(19) United States
(12) Patent Application Publication
(10) Pub. No.: US 2026/0088308 A1
(43) Pub. Date: Mar. 26, 2026

(54) POROUS CATALYST SUPPORT AND ITS METHOD OF PRODUCTION

(71) Applicant: Triad National Security, LLC, Los Alamos, NM (US)

(72) Inventors: Jacob Schatz Spendelow, Los Alamos, NM (US); Kate Chen, Los Alamos, NM (US); Kui Li, Los Alamos, NM (US); Xiaojing Wang, Los Alamos, NM (US)

(21) Appl. No.: 19/338,559

(22) Filed: Sep. 24, 2025

Related U.S. Application Data
(60) Provisional application No. 63/698,206, filed on Sep. 24, 2024.

(51) Int. Cl. H01M 4/86; C01B 32/05; H01M 4/92; H01M 8/10

(52) U.S. Cl. CPC H01M 4/8605; C01B 32/05; H01M 4/8657; H01M 4/92; H01M 2004/8689; H01M 2008/1095

(57) ABSTRACT

Porous catalyst support and methods for producing same are provided herein. An example porous catalyst support includes a porous material defining a plurality of pores, wherein the porous material comprises a porous carbon material, the plurality of pores comprises a plurality of micropores and a plurality of mesopores, and a porosity of the porous catalyst has a predetermined volume of micropores and of mesopores.

### CROSS-REFERENCE TO RELATED APPLICATIONS

The present application claims priority to U.S. Provisional Application Ser. No. 63/698,206, titled “POROUS CATALYST SUPPORT AND ITS METHOD OF PRODUCTION”, filed Sep. 24, 2024, the entire contents of which are incorporated herein by reference.

### STATEMENT REGARDING GOVERNMENT SUPPORT

This invention was made with government support under Contract No. 89233218CNA000001 awarded by the U.S. Department of Energy. The government has certain rights in the invention.

### TECHNOLOGICAL FIELD

Example embodiments of the present disclosure relate generally to catalyst supports, and more particularly, to porous catalyst supports with controlled porosity and pore size distribution, supported catalysts, and processes for the production thereof.

### BACKGROUND

A fuel cell is an electrochemical cell that converts chemical energy in a fuel and an oxidizing agent directly into electrical energy through an electrochemical reaction (i.e., a pair of redox reactions). While fuel cells containing conventional catalyst supports are typically regarded as efficient and provide such energy conversion, the inventors have identified a number of deficiencies and problems in the conventional catalyst supports of such fuel cells and other electrochemical devices. Through applied effort, ingenuity, and innovation, many of these identified deficiencies and problems have been solved by developing solutions that are structured in accordance with the embodiments of the present disclosure, many examples of which are described in detail herein.

### BRIEF SUMMARY

Various embodiments of the present disclosure are directed to porous catalyst supports and methods for producing same. In accordance with some exemplary embodiments of the present disclosure, a porous catalyst support is provided. In some embodiments, the porous catalyst support includes a porous material defining a plurality of pores, wherein the porous material comprises a porous carbon material, wherein the plurality of pores comprises a plurality of micropores and a plurality of mesopores, and wherein a porosity of the porous catalyst has a predetermined volume of micropores and of mesopores.

In some embodiments, the porous carbon material is based on a carbonized metal organic framework. In some further embodiments, the carbonized metal organic framework is a carbonized zeolitic imidazolate framework-8 (ZIF-8).

In some embodiments, a majority of the plurality of pores are micropores. In some further embodiments, the plurality of pores comprises more than 60% micropores. In still some further embodiments, the plurality of pores comprises more than 70% micropores. In still certain embodiments, the plurality of pores comprises more than 80% micropores.

In some embodiments, a majority of the plurality of pores are mesopores. In some further embodiments, the plurality of pores comprises more than 60% mesopores. In still some further embodiments, the plurality of pores comprises more than 70% mesopores. In still certain embodiments, the plurality of pores comprises more than 80% mesopores.

In some embodiments, the porosity of the porous catalyst support is greater than about 0.1 ml/g and less than about 10 ml/g. In some further embodiments, the porosity of the porous catalyst support is greater than about 0.2 ml/g and less than about 1 ml/g.

In accordance with some exemplary embodiments of the present disclosure, a supported catalyst is provided. The supported catalyst includes a porous catalyst support, the porous catalyst support comprising a porous material defining a plurality of pores, wherein the porous material comprises a porous carbon material, the plurality of pores comprises a plurality of micropores and a plurality of mesopores, and a porosity of the porous catalyst has a predetermined volume of micropores and of mesopores; and a catalytically effective amount of a catalyst material supported by the porous catalyst support.

In some embodiments, the porous carbon material is based on a carbonized metal organic framework. In some further embodiments, the carbonized metal organic framework is a carbonized zeolitic imidazolate framework-8 (ZIF-8).

In some embodiments, a majority of the plurality of pores of the porous catalyst support are micropores. In other embodiments, a majority of the plurality of pores of the porous catalyst support are mesopores.

In some embodiments, the porosity of the porous catalyst support is greater than about 0.1 ml/g and less than about 10 ml/g.

In accordance with some exemplary embodiments of the present disclosure, a low-temperature polymer electrolyte membrane fuel cell is provided. The low-temperature polymer electrolyte membrane fuel cell includes an anode; a cathode; and an electrolyte membrane, wherein at least the cathode comprises a porous material defining a plurality of pores, wherein the porous material comprises a porous carbon material, the plurality of pores comprises a plurality of micropores and a plurality of mesopores, and a porosity of the porous catalyst has a predetermined volume of micropores and of mesopores; a catalytically effective amount of a catalyst material supported by the porous catalyst support; and an ion-conducting polymer.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the figures in accordance with an example embodiment of the present disclosure.

FIGS. 1A-1E illustrate example porous catalyst supports structured in accordance with various example embodiments of the present disclosure.

FIGS. 2A-2D illustrate an example electrode structured in accordance with various example embodiments of the present disclosure.

FIG. 3 illustrates an example polymer electrolyte membrane fuel cell (PEMFC) structured in accordance with various example embodiments of the present disclosure.

FIG. 4 depicts a flowchart broadly illustrating a series of steps that are performed to fabricate a porous catalyst support structured in accordance with an example embodiment of the present disclosure.

FIG. 5 shows performance data for fuel cells with MEAs based on three different Pt/C catalysts (at beginning of life, labeled BOL), including two conventional Pt/C catalyst (TEC10V40E and TEC10E40E) and one that is consistent with embodiments of the present disclosure (Pt/CZIF8).

FIG. 6 shows performance data (at end of life, labeled EOL) for fuel cells with MEAs based on three different Pt/C catalysts, including two conventional Pt/C catalyst (TEC10V40E and TEC10E40E) and one Pt/C catalyst consistent with embodiments of the present disclosure (Pt/CZIF8).

FIG. 7 shows performance data for a fuel cell (at beginning of life, labeled BOL) with an MEA consistent with embodiments of the present disclosure (Pt/CZIF8).

### DETAILED DESCRIPTION

Example embodiments now will be more fully described with reference to the accompanying drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details. It should be understood that some, but not all, embodiments of the present disclosure are shown and described herein. Indeed, embodiments of the present disclosure may be embodied in many different forms, and accordingly this disclosure should not be construed as limited to the embodiments set forth herein; rather, these embodiments are provided so that this disclosure will satisfy applicable legal requirements.

### Overview

A specific type of fuel cell is a polymer electrolyte membrane fuel cell (PEMFC), which is formed as a membrane electrode assembly. In a membrane electrode assembly, an electrolyte membrane is positioned between an anode and a cathode and the PEMFC utilizes the oxidation of fuel, such as hydrogen, at the anode to split hydrogen molecules into protons and electrons. The protons are transported from the anode, across the electrolyte membrane, and to the cathode where the protons react with oxygen to produce water, which is removed from the PEMFC. Electrons are transported via an external circuit from the anode to the cathode of the PEMFC, thereby providing power to external devices. Catalysts at each electrode facilitate the two half-cell reactions, the hydrogen oxidation reaction (HOR) at the anode and the oxygen reduction reaction (ORR) at the cathode, to drive such production of electrical power:

$${H}_{2} \to 2 {H}^{+} + 2 {e}^{-} \qquad ( 1 )$$

$${O}_{2} + 4 {H}^{+} + 4 {e}^{-} \to 2 {H}_{2} O \qquad ( 2 )$$

Thus, effective transport of multiple species (O₂, H⁺, e⁻, and H₂O) to and from catalytic sites is a critical aspect of the PEMFC.

An electrode structure (e.g., anode or cathode) in a fuel cell is typically composed of an ion-conducting polymer and/or a non-conducting polymer, a catalyst support, and a catalyst. Conventional catalyst supports typically include a carbon support upon which nanometer-sized catalyst particles are dispersed. PEMFCs based on conventional catalyst supports suffer from significant barriers to the achievement of high performance, such as the conflicting needs of ionic (e.g., H⁺) and neutral molecule (e.g., O₂) transport. The inventors have determined it would be desirable and advantageous to provide an improved porous catalyst support to enable enhanced performance of fuel cells, such as low-temperature polymer electrolyte membrane fuel cells (LT-PEMFC), and other electrochemical devices.

To overcome these problems and others, various embodiments of the present disclosure are directed to porous catalyst supports and methods for producing same. In some example embodiments of the present disclosure, a porous catalyst support utilizes increased porosity and/or controlled pore size distribution to provide different transport functions by different regions of the porous catalyst support. In other words, a porous catalyst support in accordance with the present disclosure may include differentiated transport channels, composed of porous and/or solid regions, which may provide for improved transport of the different species in the fuel cell or other electrochemical device.

In the present disclosure, porosity refers to the pore volume of the porous catalyst support while pore size distribution refers to the sizing and distribution (e.g., pore size ratio) of the pores that form the porosity of the porous catalyst support. The inventors have determined that increasing the porosity of a catalyst support would be desirable and advantageous to promote ionic and neutral molecule transport to, for example, the catalytically active sites contained in the porous catalyst support.

The inventors have determined that, in addition to increased porosity, a network of pores with a controlled pore size distribution in which certain pores may be configured to preferentially provide ionic (H⁺) transport, while other pores may be configured to preferentially provide neutral molecule (O₂) transport is desirable and advantageous. For example, micropores, which are pores having a diameter or width smaller than approximately 2 nm, may preferentially provide ionic (H⁺) transport and mesopores, which are pores having a diameter or width of approximately 2 nm to 15 nm, may preferentially provide neutral molecule (O₂) transport. Accordingly, the inventors have also determined that the combined and controlled presence of both micropores and mesopores in some example porous catalyst supports of the present disclosure would be desirable and advantageous to enable the effective transport of both protons and oxygen molecules to, for example, catalytically active sites contained in the porous catalyst support (e.g., catalytically active metal atoms or clusters coordinated by heteroatoms) or catalytically active metal nanoparticles, which may be deposited on the surface or within the porous catalyst support, thereby enabling effective oxygen reduction reaction (ORR) catalysis in the cathode of a fuel cell. For example, smaller micropores in a porous catalyst support of the present disclosure may be flooded with liquid-like water under typical relative humidity conditions, such water phase provides effective transport of ions, namely protons (H⁺). Meanwhile, larger mesopores remain largely free of liquid-like water, and thus, may provide open void space for effective transport of neutral molecules, namely oxygen molecules (O₂).

The inventors have determined that controlling the ratio of such bi-modal or multi-modal pore sizes would also be desirable and advantageous. For example, some fuel cells may be operated in hotter and drier conditions. In such conditions, less condensed water is located in the pores which results in slower proton transport since a majority of the proton transport occurs through the condensed water. The inventors have determined it would be desirable and advantageous to utilize a porous catalyst support with a higher ratio of micropores in such hot and dry conditions in order to improve proton transport. Oxygen, or neutral molecule, transport is typically improved in such hot and dry conditions because when less condensed water is present, there is less concern of anything blocking the oxygen transport which typically occurs in the mesopores. For fuel cells or other electrochemical devices operated in colder and wetter conditions, the inventors have determined it would be desirable and advantageous to utilize a porous catalyst support with a higher ratio of mesopores in order to improve oxygen transport since there is an increase of condensed water which may at least partially block mesopores. Proton transport may be improved in such cold and wet conditions since a majority of the proton transport occurs through the condensed water such that the inventors have determined that not as many micropores would be needed. Accordingly, the inventors have determined that it would be desirable and advantageous to control and/or tailor the sizing and distribution (e.g., pore size ratio) of the pores, in addition to increasing the overall porosity, of a porous catalyst support in accordance with the present disclosure. By separating different transport functions into different channels, the inventors have determined that each channel can be optimized for its specific function, thereby enabling faster transport, and thus increasing catalytic performance, even enabling improved performance under high humidity/lower temperature and low humidity/higher temperature conditions.

A porous catalyst support in accordance with the present disclosure may be composed of a porous material, such as a carbon-based material containing a network of pores. In an example embodiment, the porous catalyst support is based on a metal organic framework (MOF), such as a carbonized zeolitic imidazolate framework (e.g., ZIF-8), which is a porous carbon structure containing distinct pore populations, which may be controlled by manipulating one or more of a variety of process parameters in its formation (e.g., reactant concentration such as the ratio between metal salt and ligands, process time(s), reaction temperature(s), gases, etc.). Porous catalyst supports of the present disclosure are not limited to ZIF-8 or even to carbon-based materials and the present disclosure contemplates any of a variety of metal organic frameworks or non-carbon-based materials containing such network of pores.

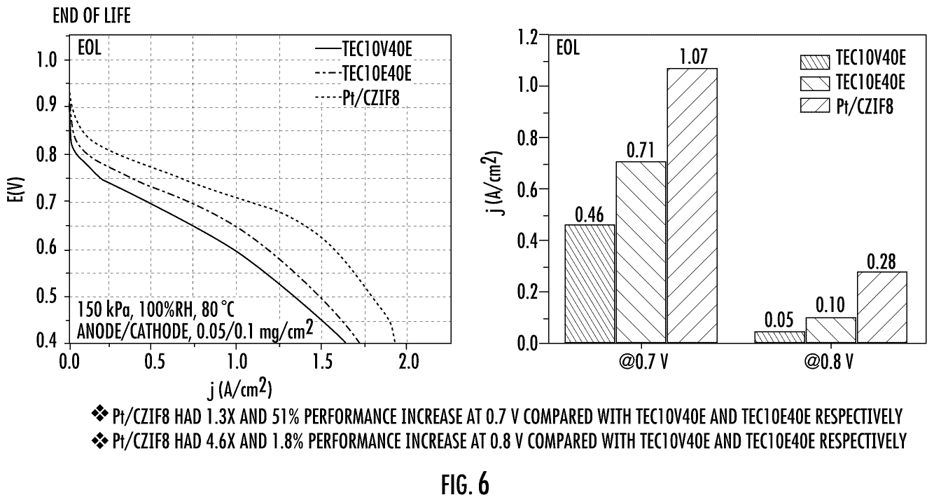

Porous catalyst supports of the present disclosure provide improved fuel cell performance compared to conventional catalyst supports. For example, LT-PEMFCs comprising porous catalyst support(s) with a controlled porosity and pore size distribution in accordance with the present disclosure perform significantly better, providing higher power density and higher efficiency, than LT-PEMFCs using conventional non-porous catalyst supports, such as Vulcan XC72, or other porous catalyst supports that are formed with uncontrolled or randomized pore size or pore size distribution, such as Ketjenblack. Specific comparison data is described below in relation to FIGS. 5 and 6.

These characteristics as well as additional features, functions, and details are described below. Similarly, corresponding and additional embodiments are also described below. The various implementations of the porous catalyst support of the present disclosure are not limited to ORR catalysts or low temperature polymer electrolyte membrane fuel cells and can instead be configured for use with other technologies that might be of interest to a user. That is, one of ordinary skill in the art will appreciate that the porous catalyst support related concepts discussed herein may be applied to a wide variety of other fuel cell, electrochemical, or catalytic technologies.

### Exemplary Embodiments of the Present Disclosure

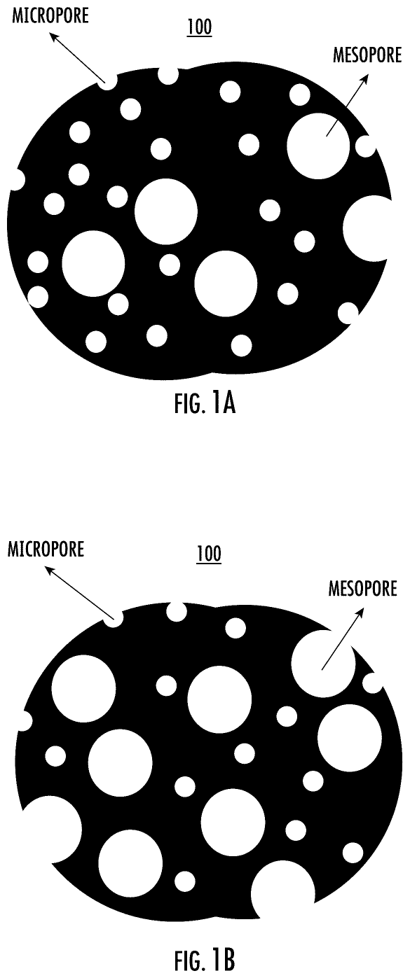

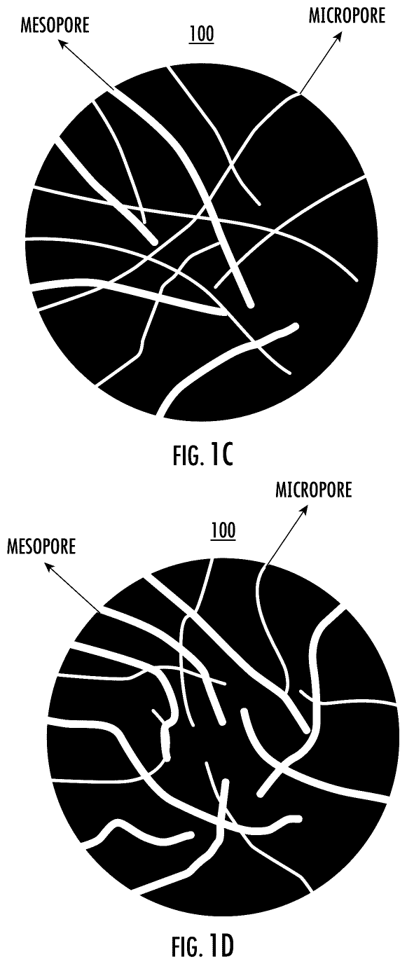

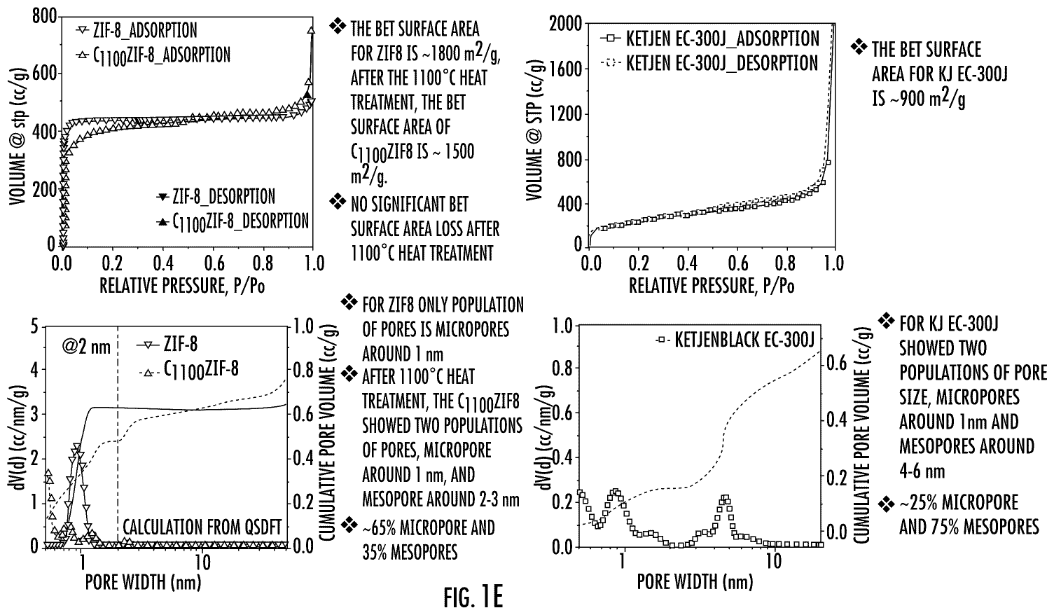

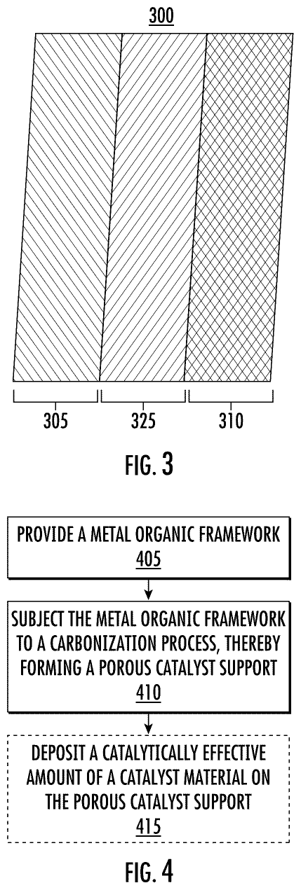

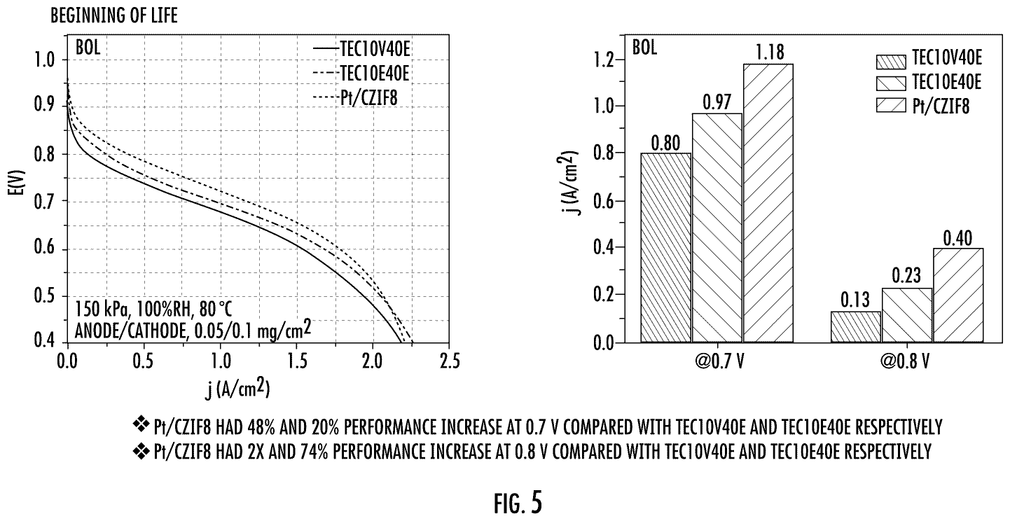

FIGS. 1A-ID depict example porous catalyst supports 100 according to various embodiments of the present disclosure. As shown in FIGS. 1A-ID, an example porous catalyst support may comprise a porous material. The porous material may be formed from any of a variety of materials. For example, in some embodiments, the porous catalyst support may comprise a carbon-based porous material. In certain embodiments, the porous catalyst support comprises an electroconductive carbon-based porous material. For example, as set forth in more detail with respect to FIG. 4, the porous catalyst support may be based on a carbonized metal organic framework, such as a carbonized zeolitic imidazolate framework (e.g., ZIF-8), which is a porous carbon structure containing distinct pore populations. For example, as depicted in FIG. 1E, there is no significant BET surface area loss after subjecting zeolitic imidazolate framework (e.g., ZIF-8) to 1100° C. heat treatment, thereby forming the porous catalyst support 100 with a predetermined volume of micropores (e.g., ˜65%) and of mesopores (e.g., ˜35%), as compared to the uncontrolled or randomized pore size or pore size distribution of Ketjenblack, as depicted on the right side of FIG. 1E. In some embodiments, the porous catalyst support may comprise a non-carbon-based porous material, such as zeolites or other inorganic ceramic material.

As depicted in FIGS. 1A-ID, the porous material of the porous catalyst support may define a plurality of pores. The pores of the porous catalyst support provide mass transport channels for the various species in the catalyst support. The present disclosure contemplates that the pores of the porous catalyst support may be of any suitable shape.

In some embodiments, the plurality of pores comprises one or more pores structured to preferentially provide ionic transport, for example, proton (H⁺) transport. For example, in some embodiments, one or more pores may be sized such that the pore preferentially provides ionic transport (e.g., as compared to neutral molecule transport). In certain embodiments, the plurality of pores comprises one or more micropores, which are pores having a diameter or width smaller than approximately 2 nm. By “diameter” or “width”, it is meant the largest distance between two points on a surface of a pore wall. In some embodiments, the diameter or width of at least one micropore of the present disclosure is between 0.01 nm-2.00 nm. In an embodiment, the diameter or width of at least one micropore is less than about 1.90 nm, less than about 1.80 nm, less than about 1.70 nm, less than about 1.60 nm, less than about 1.50 nm, less than about 1.40 nm, less than about 1.30 nm, less than about 1.25 nm, less than about 1.20 nm, less than about 1.15 nm, less than about 1.10 nm, less than about 1.00 nm, less than about 0.90 nm, less than about 0.80 nm, less than about 0.70 nm, less than about 0.60 nm, less than about 0.50 nm, less than about 0.40 nm, less than about 0.30 nm, less than about 0.20 nm, less than about 0.10 nm, less than about 0.05 nm, or less than about 0.01 nm. In some embodiments, the diameter or width of at least one micropore is greater than about 0.01 nm, greater than about 0.02 nm, greater than about 0.03 nm, greater than about 0.04 nm, greater than about 0.05 nm, greater than about 0.06 nm, greater than about 0.07 nm, greater than about 0.08 nm, greater than about 0.09 nm, greater than about 0.10 nm, greater than about 0.20 nm, greater than about 0.30 nm, greater than about 0.40 nm, greater than about 0.50 nm, greater than about 0.60 nm, greater than about 0.70 nm, greater than about 0.80 nm, greater than about 0.90 nm, greater than about 1.00 nm, greater than about 1.10 nm, greater than about 1.20 nm, greater than about 1.30 nm, greater than about 1.40 nm, greater than about 1.50 nm, greater than about 1.60 nm, greater than about 1.70 nm, greater than about 1.80 nm, or greater than about 1.90 nm.

In some embodiments, the plurality of pores comprises one or more pores structured to preferentially provide neutral molecule transport, for example, oxygen (O₂) transport. For example, in some embodiments, one or more pores may be sized such that the pore preferentially provides neutral molecule transport (e.g., as compared to ionic transport). In certain embodiments, the plurality of pores comprises one or more mesopores, which are pores having a diameter or width between approximately 2 nm and 15 nm. In some embodiments, the diameter or width of at least one mesopore of the present disclosure is between 2.0 nm and 15.0 nm. In an embodiment, the diameter or width of at least one mesopore is less than about 14.5 nm, less than about 14.0 nm, less than about 13.5 nm, less than about 13.0 nm, less than about 12.5 nm, less than about 12.0 nm, less than about 11.5 nm, less than about 11.0 nm, less than about 10.5 nm, less than about 10.0 nm, less than about 9.5 nm, less than about 9.0 nm, less than about 8.5 nm, less than about 8.0 nm, less than about 7.5 nm, less than about 7.0 nm, less than about 6.5 nm, less than about 6.0 nm, less than about 5.5 nm, less than about 5.0 nm, less than about 4.5 nm, less than about 4.0 nm, less than about 3.5 nm, less than about 3.0 nm, or less than about 2.5 nm. In some embodiments, the diameter or width of at least one mesopore is greater than about 2.5 nm, greater than about 3.0 nm, greater than about 3.5 nm, greater than about 4.0 nm, greater than about 4.5 nm, greater than about 5.0 nm, greater than about 5.5 nm, greater than about 6.0 nm, greater than about 6.5 nm, greater than about 7.0 nm, greater than about 7.5 nm, greater than about 8.0 nm, greater than about 8.5 nm, greater than about 9.0 nm, greater than about 9.5 nm, greater than about 10.0 nm, greater than about 10.5 nm, greater than about 11.0 nm, greater than about 11.5 nm, greater than about 12.0 nm, greater than about 12.5 nm, greater than about 13.0 nm, greater than about 13.5 nm, greater than about 14.0 nm, or greater than about 14.5 nm.

The plurality of pores of the porous material defines a porosity of the porous catalyst support 100. The porosity refers to a total pore volume of the porous catalyst support 100. In some embodiments, the porosity (e.g., total pore volume) of the porous catalyst support 100 is greater than about 0.005 ml/g, greater than about 0.01 ml/g, greater than about 0.05 ml/g, greater than about 0.1 ml/g, greater than about 0.2 ml/g, greater than about 0.3 ml/g, greater than about 0.4 ml/g, greater than about 0.5 ml/g, greater than about 0.6 ml/g, greater than about 0.7 ml/g, greater than about 0.8 ml/g, greater than about 0.9 ml/g, greater than about 1 ml/g, greater than about 2 ml/g, or greater than about 5 ml/g.

In some embodiments, the porosity of the porous catalyst support 100 is less than about 15 ml/g, less than about 10 ml/g, less than about 5 ml/g, less than about 2 ml/g, less than about 1 ml/g, or less than about 0.5 ml/g. For example, in some embodiments, the porosity of the porous catalyst support 100 is greater than about 0.005 ml/g and less than about 15 ml/g, greater than about 0.1 ml/g and less than about 10 ml/g, greater than about 0.2 ml/g and less than about 10 ml/g, greater than about 0.2 ml/g and less than about 5 ml/g, greater than about 0.2 ml/g and less than about 1 ml/g, greater than about 0.3 ml/g and less than about 1 ml/g, greater than about 0.4 ml/g and less than about 1 ml/g, or greater than about 0.5 ml/g and less than about 1 ml/g.

In some embodiments, the porous material defines a pore size distribution of the plurality of pores. That is, in some embodiments, the plurality of pores comprises a plurality of micropores and a plurality of mesopores. In certain embodiments, a majority of the pores of the porous material are micropores. That is, a greater ratio of the porosity is micropores than mesopores. For example, in some embodiments, the fuel cell in which a porous catalyst support 100 of the present disclosure is disposed is intended to operate in a hot and dry environment. In such embodiments, the porous material may be configured to include more micropores than mesopores in order to improve proton transport. FIGS. 1A and 1C depict a porous catalyst support 100 having more micropores than mesopores.

In certain other embodiments, a majority of the pores of the porous material comprises mesopores. That is, a greater ratio of the porosity is mesopores than micropores. For example, in some embodiments, the fuel cell in which a porous catalyst support 100 of the present disclosure is disposed is intended to operate in a cold and wet environment. In such embodiments, the porous material may be configured to include more mesopores than micropores. Such pore size distribution or pore size ratio may improve oxygen transport. FIGS. 1B and 1D depict a porous catalyst support 100 having more mesopores than micropores. In some other embodiments, the porosity of the porous material comprises about the same amount of micropores as mesopores.

In some embodiments, the porosity of the porous material comprises about 1-99% micropores. In certain embodiments, the porosity of the porous material comprises about 1-50% micropores. In certain other embodiments, the porosity of the porous material comprises about 50-99% micropores. In certain embodiments, the porosity of the porous material comprises greater than about 1% micropores, 5% micropores, 10% micropore, 15% micropores, 20% micropores, 25% micropores, 30% micropores, 35% micropores, 40% micropores, 45% micropores, 50% micropores, 55% micropores, 60% micropores, 65% micropores, 70% micropores, 75% micropores, 80% micropores, 85% micropores, 90% micropores, 95 micropores, or 99% micropores. In certain embodiments, the porous material comprises less than about 99% micropores, 95% micropores, 90% micropores, 85% micropores, 80% micropores, 75% micropores, 70% micropores, 65% micropores, 60% micropores, 55% micropores, 50% micropores, 45% micropores, 40% micropores, 35% micropores, 30% micropores, 25% micropores, 20% micropores, 15% micropores, 10% micropores, 5% micropores, 3% micropores, or 1% micropores.

In some embodiments, the porosity of the porous material comprises about 1-99% mesopores. In certain embodiments, the porosity of the porous material comprises about 1-50% mesopores. In certain other embodiments, the porosity of the porous material comprises about 50-99% mesopores. In certain embodiments, the porosity of the porous material comprises greater than about 1% mesopores, 5% mesopores, 10% mesopores, 15% mesopores, 20% mesopores, 25% mesopores, 30% mesopores, 35% mesopores, 40% mesopores, 45% mesopores, 50% mesopores, 55% mesopores, 60% mesopores, 65% mesopores, 70% mesopores, 75% mesopores, 80% mesopores, 85% mesopores, 90% mesopores, 95 mesopores, or 99% mesopores. In certain embodiments, the porous material comprises less than about 99% mesopores, 95% mesopores, 90% mesopores, 85% mesopores, 80% mesopores, 75% mesopores, 70% mesopores, 65% mesopores, 60% mesopores, 55% mesopores, 50% mesopores, 45% mesopores, 40% mesopores, 35% mesopores, 30% mesopores, 25% mesopores, 20% mesopores, 15% mesopores, 10% mesopores, 5% mesopores, 3% mesopores, or 1% mesopores.

In some embodiments, a catalytically effective amount of one or more catalyst materials are supported on the porous catalyst support 100. Non-limiting examples of catalyst materials include, but are not limited to, platinum (Pt), palladium (Pd), cobalt (Co), nickel (Ni), gold (Au), silver (Ag), iridium (Ir), etc., and their alloys. In some embodiments, the one or more catalyst materials are nanoparticles deposited onto the porous catalyst support 100. For example, in some embodiments, the catalyst material is Pt or Pt-alloy nanoparticles deposited onto the porous catalyst support 100 as a catalyst ink.

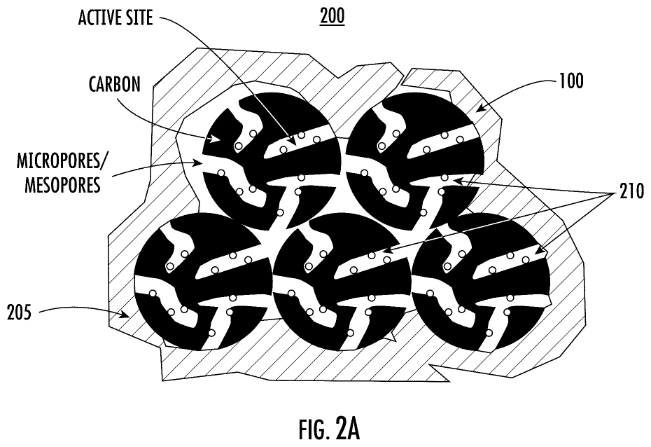

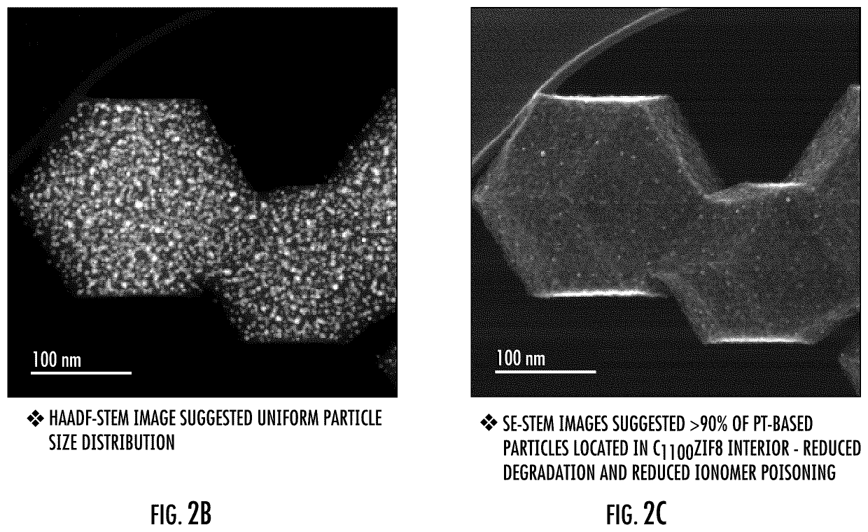

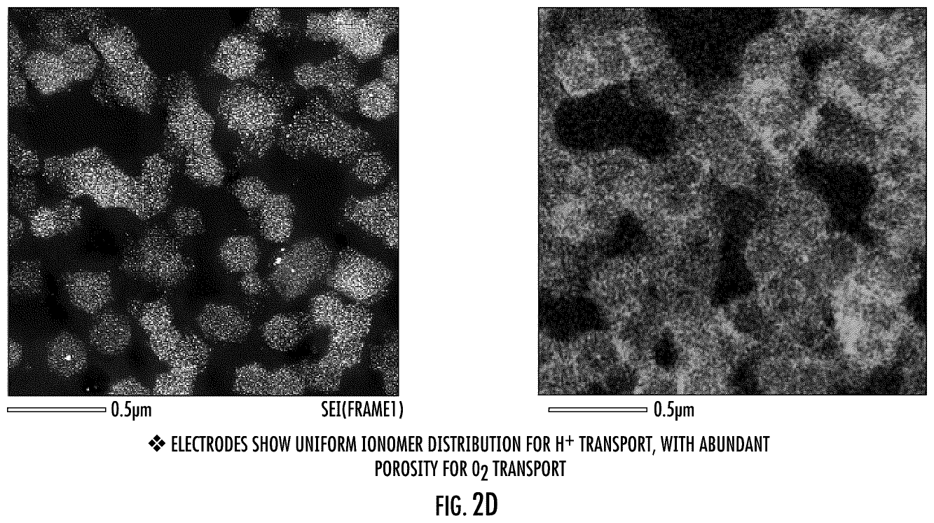

In still further embodiments, as depicted in FIG. 2A, an electrode structure 200 may comprise a porous catalyst support 100 according to example embodiments of the present disclosure. In the example embodiment depicted in FIG. 2A, the electrode structure 200 (e.g., anode or cathode) comprises an ion-conducting polymer (e.g., ionomer) material 205, the porous catalyst support 100, and a catalyst material 210. For example, the ion-conducting polymer (e.g., ionomer) material 205 may be intermixed with the catalyst material(s) 210 and deposited on the porous catalyst support 100. FIG. 2B reflects an HAADF-STEM image of an electrode structure 200 in accordance with the present disclosure, the image suggests uniform particle distribution. FIG. 2C reflects an SE-STEM image of an electrode structure 200 in accordance with the present disclosure, the image suggesting that more than 90% of Pt-based particles are located in C1100ZIF8 interior, therefore providing reduced degradation and reduced ionomer poisoning. Still further, FIG. 2D reflects additional images of electrode structures 200 in accordance with the present disclosure, the electrode structures 200 showing ionomer distribution for H+ transport with abundant porosity for O₂ transport.

As used herein, an “ionomer” refers to a polymer having repeating electrically neutral unit and ionized units covalently bonded to a polymer backbone. In at least some embodiments, the ion-conducting polymer (e.g., ionomer) material 205 may comprise perfluorosulfonic acid (PFSA), perfluoroimide acid (PFIA), sulfonated hydrocarbon ionomers, alkaline ionomers, or high temperature ionomers such as phosphoric acid doped polybenzimidazole. In still further embodiments, the ion-conducting polymer (e.g., ionomer) material 205 may comprise one or more thermoplastic polymers such as, for example, Nafion™ (a sulfonated tetrafluoroethylene based fluoropolymer-copolymer produced by The Chemours Company), Nafion™ 211 (The Chemours Company), Nafion™ XL (The Chemours Company), Nafion™ HP (The Chemours Company), Aquivion® (a short-side-chain copolymer of tetrafluoroethylene and the sulfonyl fluoride vinyl ether (SFVE) CF₂=CF₂—O—(CF₂)₂—SO₂F, produced by Solvay Specialty Polymers), and Flemion™ (a fluorinated membrane available from AGC Chemicals Company).

In still further embodiments, as depicted in FIG. 3, a PEMFC 300 may comprise one or more porous catalyst supports 100 according to example embodiments of the present disclosure. The PEMFC 300 may have an electrode (anode)/electrolyte membrane/electrode (cathode) architecture, such as that illustrated in FIG. 3. FIG. 3 is a view of a PEMFC 300 according to at least some embodiments of the present disclosure. As illustrated, the PEMFC 300 includes an anode 305, an electrolyte membrane 325, and a cathode 310. The anode 305 and/or cathode 310 may comprise an electrode structure 200 including a porous catalyst support 100 according to various embodiments of the present disclosure. In some embodiments, the anode 305 may include an anode gas-diffusion layer (or “backing”). Similarly, the cathode 310 may include a cathode gas-diffusion layer. Generally, the gas-diffusion layers may allow for reactant transport and heat/water removal, provide mechanical support to the membrane electrode assembly, and provide protection to the catalyst layer from corrosion or erosion. The gas-diffusion layers may be a porous material having a dense array of carbon fibers. Example gas-diffusion layers are carbon paper (a non-woven material) and carbon cloth (a woven fabric). The gas-diffusion layers may be wet-proofed by treatment with poly-tetrafluoroethylene (PTFE). In some embodiments, the anode 305 and/or cathode 310 may further include a current collector plate, which may be made of, for example, graphite, stainless steel, aluminum, titanium, or composite materials.

The electrolyte membrane 325 is positioned between the anode 305 and the cathode 310. The electrolyte membrane 325 is a proton conducting membrane, enabling protons from the anode 305 to be transferred to the cathode 310. In some embodiments, the electrolyte membrane 325 may comprise an ionomer or other ion conductor. In certain embodiments, the electrolyte membrane 325 is an ionomer membrane made of one or more commercially available and/or one or more proprietary ionomers. In at least some embodiments, an ionomer of the present disclosure may be a thermoplastic resin stabilized by ionic cross-linkages. That is, an ionomer of the present disclosure may be a polymer. Example ionomers that may be used in accordance with the present disclosure include, but are not limited to perfluorosulfonic acid (PFSA), perfluoroimide acid (PFIA), sulfonated hydrocarbon ionomers, alkaline ionomers, and high temperature ionomers such as phosphoric acid doped polybenzimidazole. In at least some embodiments, the ionomer membrane 325 may include one or more thermoplastic polymers such as, for example, Nafion™ (a sulfonated tetrafluoroethylene based fluoropolymer-copolymer produced by The Chemours Company), Nafion™ 211 (The Chemours Company), Nafion™ XL (The Chemours Company), Nafion™ HP (The Chemours Company), Aquivion® (a short-side-chain copolymer of tetrafluoroethylene and the sulfonyl fluoride vinyl ether (SFVE) CF₂=CF₂—O—(CF₂)₂—SO₂F, produced by Solvay Specialty Polymers), and Flemion™ (a fluorinated membrane available from AGC Chemicals Company). Although depicted with reference to an ionomer membrane, the electrolyte membrane 325 of the present disclosure may be configured for use in any application without limitation and may include any type of electrolyte material, including but not limited to non-ionomer materials, in order to provide the ion conducting capabilities associated with the associated application. Said differently, although described herein with reference to an ionomer membrane, a myriad of other electrolyte materials are contemplated by this disclosure and the disclosure is not limited to an ionomer membrane.

### Example Methods

Having described the exemplary porous catalyst support of the present disclosure, it should be understood that the porous catalyst support may be fabricated in a number of ways. FIG. 4 is a flowchart broadly illustrating a series of steps that are performed to fabricate a porous catalyst support of the present disclosure, for example, the porous catalyst support 100 as described above.

As shown in step 405, a metal organic framework (MOF) is provided. For example, in some embodiments, a zeolitic imidazolate framework, such as ZIF-8, is provided. A ZIF is composed of tetrahedrally-coordinated transition metal ions (e.g., iron, cobalt, zinc ions) connected by imidazolate linkers. Other metal organic frameworks, such as other ZIFs, are contemplated by the disclosure and can be used without deviating from this disclosure.

The process parameters for forming the MOF may be adjusted, modified, or otherwise varied in order to control or tailor the resulting porosity and/or pore size distribution of the MOF (and ultimately the porous catalyst support formed therefrom). For example, controlling concentrations of the reactants, such as the ratio between the metal salt and ligands, may affect/control pore size. Other parameters such as time, temperature, gases, etc. may be manipulated to otherwise control the porosity and/or pore ratio of the MOF.

As shown in step 410, the metal organic framework is subjected to a carbonization process in order to remove the metal ends from the metal organic framework and form a porous catalyst support. A carbonization process is a process by which organic material is converted into carbon or carbon or carbon-containing residue by thermal decomposition at high temperatures, such as via pyrolysis in an inert atmosphere. For example, the metal organic framework may be pyrolyzed under a forming gas, such as dilute hydrogen, nitrogen, or argon. For example, in some embodiments, the zeolitic imidazolate framework, such as ZIF-8, is subjected to a 1100° C. heat treatment. During such carbonization process, the metal(s) of the metal organic framework, which is a non-oxidized metal, evaporates and it is volatile at such temperatures (e.g., boiling point of zinc metal is approximately 907° C.).

As shown in step 415, a catalytically effective amount of a catalyst material is optionally deposited on the porous catalyst support formed in step 410. For example, Pt or Pt-alloy nanoparticles are deposited onto the porous catalyst support of step 410 as a catalyst ink, in one embodiment.

### Example Catalysts and Devices

FIG. 5 shows performance data for fuel cells with MEAs based on three different Pt/C catalysts (at beginning of life, labeled BOL), including two conventional Pt/C catalyst (TEC10V40E and TEC10E40E) and one that is consistent with embodiments of the present disclosure (Pt/CZIF8). Pt/CZIF8 is a catalyst prepared using the porous carbon support with differentiated transport channels consistent with embodiments of the present disclosure. TEC10V40E and TEC10E40E are commercial Pt/C catalysts that include a conventional non-porous carbon (TEC10V40E) and a conventional porous carbon (TEC10E40E), respectively. As can be seen in FIG. 5, Pt/CZIF8 has 48% and 20% performance increase at 0.7 V compared with TEC10V40E and TEC10E40E respectively. Also, Pt/CZIF8 has 2× and 74% performance increase at 0.8 V compared with TEC10V40E and TEC10E40E, respectively.

FIG. 6 shows performance data for fuel cells with MEAs based on the three different Pt/C catalysts, described above with respect to FIG. 5, namely (Pt/CZIF8; TEC10V40E; and TEC10E40E). The data in FIG. 6 is after a durability test of MEAs and therefore the tests are at end of life, labeled EOL. As can be seen in FIG. 6, Pt/CZIF8 had 1.3× and 51% performance increase at 0.7 V compared with TEC10V40E and TEC10E40E, respectively. Additionally, Pt/CZIF8 had 4.6× and 1.8× performance increase at 0.8 V compared with TEC10V40E and TEC10E40E, respectively.

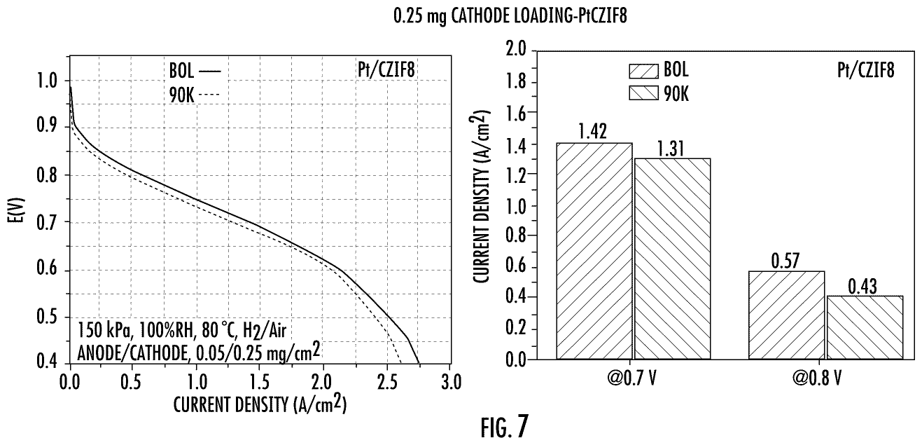

FIG. 7 shows performance data for a fuel cell with an MEA based on the present disclosure (Pt/CZIF8) with a higher catalyst loading in the cathode than shown in FIG. 5.

Thus, particular embodiments of the subject matter have been described. While this specification contains many specific implementation details, these should not be construed as limitations on the scope of any embodiments or of what may be claimed, but rather as description of features specific to particular embodiments of the present disclosure. Other embodiments are within the scope of the following claims. It is evident that many alternatives, modifications, and variations will be apparent to those skilled in the art in light of the foregoing description. It is therefore contemplated that the appended claims will embrace any such alternatives, modifications, and variations as falling within the scope and spirit of the present disclosure.

Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while steps or processes are depicted in the drawings in a particular order, this should not be understood as requiring that such steps or processes be performed in the particular order shown or in sequential order, or that all illustrated steps or processes be performed, to achieve desirable results, unless described otherwise. Said differently, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

### Overview of Terms

For the purposes of the present application, the following explanations of terms are provided to better describe the present disclosure and to guide those of ordinary skill in the art in the practice of the present disclosure:

As used herein, the term “comprising” means including but not limited to and should be interpreted in the manner it is typically used in the patent context. Use of broader terms such as “comprises”, “includes”, and “having” should be understood to provide support for narrower terms such as “consisting of”, “consisting essentially of”, and “comprised substantially of”.

As used herein, the phrases “in one embodiment,” “according to one embodiment,” “in some embodiments,” and the like generally refer to the fact that the particular feature, structure, or characteristic following the phrase may be included in at least one embodiment of the present disclosure. Thus, the particular feature, structure, or characteristic may be included in more than one embodiment of the present disclosure such that these phrases do not necessarily refer to the same embodiment.

As used herein, the terms “illustrative,” “example,” “exemplary” and the like are used to mean “serving as an example, instance, or illustration” with no indication of quality level. Any implementation described herein as “exemplary” or “example” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

The terms “about,” “approximately,” “generally,” “substantially,” or the like, when used with a number, may mean that specific number, or alternatively, a range in proximity to the specific number, as understood by persons of skill in the art field and may be used to refer to within manufacturing and/or engineering design tolerances for the corresponding materials and/or elements as would be understood by the person of ordinary skill in the art, unless otherwise indicated.

It is understood that where a parameter range is provided, all integers and ranges within that range, and tenths and hundredths thereof, are also provided by the embodiments. For example, “5-10%” includes 5%, 6%, 7%, 8%, 9%, and 10%; 5.0%, 5.1%, 5.2% . . . 9.8%, 9.9%, and 10.0%; and 5.00%, 5.01%, 5.02% . . . 9.98%, 9.99%, and 10.00%, as well as, for example, 6-9%, 5.1%-9.9%, and 5.01%-9.99%. Similarly, where a list is presented, unless stated otherwise, it is to be understood that each individual element of that list, and every combination of components of that list, is a separate embodiment. For example, “1, 2, 3, 4, and 5” encompasses, among numerous embodiments, 1; 2; 3; 1 and 2; 3 and 5; 1, 3, and 5; and 1, 2, 4, and 5.

The term “plurality” refers to two or more items.

The term “set” refers to a collection of one or more items.

The term “or” is used herein in both the alternative and conjunctive sense, unless otherwise indicated.

### CONCLUSION

Many modifications and other embodiments of the present disclosure set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A porous catalyst support comprising:
a porous material defining a plurality of pores, wherein the porous material comprises a porous carbon material, the plurality of pores comprises a plurality of micropores and a plurality of mesopores, and a porosity of the porous catalyst has a predetermined volume of micropores and of mesopores.

2. The porous catalyst support of claim 1, wherein the porous carbon material is based on a carbonized metal organic framework.

3. The porous catalyst support of claim 2, wherein the carbonized metal organic framework is a carbonized zeolitic imidazolate framework-8 (ZIF-8).

4. The porous catalyst support of claim 1, wherein a majority of the plurality of pores are micropores.

5. The porous catalyst support of claim 4, wherein the plurality of pores comprises more than 60% micropores.

6. The porous catalyst support of claim 5, wherein the plurality of pores comprises more than 70% micropores.

7. The porous catalyst support of claim 6, wherein the plurality of pores comprises more than 80% micropores.

8. The porous catalyst support of claim 1, wherein a majority of the plurality of pores are mesopores.

9. The porous catalyst support of claim 8, wherein the plurality of pores comprises more than 60% mesopores.

10. The porous catalyst support of claim 9, wherein the plurality of pores comprises more than 70% mesopores.

11. The porous catalyst support of claim 10, wherein the plurality of pores comprises more than 80% mesopores.

12. The porous catalyst support of claim 1, wherein the porosity of the porous catalyst support is greater than about 0.1 ml/g and less than about 10 ml/g.

13. The porous catalyst support of claim 12, wherein the porosity of the porous catalyst support is greater than about 0.2 ml/g and less than about 1 ml/g.

14. A supported catalyst comprising:
a porous catalyst support, the porous catalyst support comprising:
a porous material defining a plurality of pores, wherein the porous material comprises a porous carbon material, the plurality of pores comprises a plurality of micropores and a plurality of mesopores, and a porosity of the porous catalyst has a predetermined volume of micropores and of mesopores; and
a catalytically effective amount of a catalyst material supported by the porous catalyst support.

15. The supported catalyst of claim 14, wherein the porous carbon material is based on a carbonized metal organic framework.

16. The supported catalyst of claim 15, wherein the carbonized metal organic framework is a carbonized zeolitic imidazolate framework-8 (ZIF-8).

17. The supported catalyst of claim 14, wherein a majority of the plurality of pores of the porous catalyst support are micropores.

18. The supported catalyst of claim 14, wherein a majority of the plurality of pores of the porous catalyst support are mesopores.

19. The supported catalyst of claim 14, wherein the porosity of the porous catalyst support is greater than about 0.1 ml/g and less than about 10 ml/g.

20. A low-temperature polymer electrolyte membrane fuel cell comprising:
an anode;
a cathode; and
an electrolyte membrane, wherein at least the cathode comprises:
a porous material defining a plurality of pores, wherein the porous material comprises a porous carbon material, the plurality of pores comprises a plurality of micropores and a plurality of mesopores, and a porosity of the porous catalyst has a predetermined volume of micropores and of mesopores;
a catalytically effective amount of a catalyst material supported by the porous catalyst support; and
an ion-conducting polymer.
